(19) United States
(12) Patent Application Publication
(10) Pub. No.: US 2024/0350956 A1
(43) Pub. Date: Oct. 24, 2024

(54) Closed Filter with Seal Washer

(71) Applicant: Parker-Hannifin Corporation, Cleveland, OH (US)

(72) Inventor: Jarod A. Lake, Prairie Village, KS (US)

(73) Assignee: Parker-Hannifin Corporation, Cleveland, OH (US)

(21) Appl. No.: 18/762,254

(22) Filed: Jul. 2, 2024

Related U.S. Application Data
(63) Continuation of application No. PCT/US2023/060387, filed on Jan. 10, 2023.
(60) Provisional application No. 63/298,354, filed on Jan. 11, 2022.

(51) Int. Cl. B01D 46/24; B01D 46/00; F16J 15/10

(52) U.S. Cl. CPC B01D 46/2411; B01D 46/0004; B01D 46/0005; F16J 15/104; B01D 2265/06; B01D 2271/022

(57) ABSTRACT

A filter element is mountable to a mast of a filter system having a threaded rod at a distal end thereof. The filter element includes cylindrical filter media, first and second end caps, and a seal washer. The media circumscribes a central axis. The first end cap is a first annular end cap and has a central opening configured for receiving the mast therethrough. The second end cap includes a seal washer opening defining a seal washer opening center that is located either concentric or non-concentric to the central axis of the media. The central opening of the first end cap is larger in dimension than the seal washer opening. The seal washer is receivable within the seal washer opening in at least a first orientation relative to the seal washer opening center. In the first orientation, a rod hole of the seal washer is non-concentric to the central axis.

### CROSS-REFERENCE TO RELATED PATENT APPLICATIONS

This patent application is a continuation of co-pending International Application No. PCT/US2023/060387, filed Jan. 10, 2023, and which designates the United States. The entire teachings and disclosure of International Application No. PCT/US2023/060387 are incorporated herein by reference thereto. International Application No. PCT/US2023/060387 claims the benefit of U.S. Provisional Patent Application No. 63/298,354, filed Jan. 11, 2022. The entire teachings and disclosures of U.S. Provisional Patent Application No. 63/298,354 are incorporated herein by reference thereto.

### FIELD OF THE INVENTION

A filter element is provided that integrates with an asymmetric, eccentric or concentric mast.

### BACKGROUND AND SUMMARY

One example of a filter element that can be integrated with a mast (or “yoke”) is shown in U.S. Pat. No. 10,350,531. The element is received over the mast, with a bottom end cap of the element sealing against a tube sheet or venturi internal to the housing, and the opposite, open, upper end cap having a seal which seals against a cover or door of the housing. The cover has a central hole which receives a mounting rod, typically in the form of a threaded rod, on the mast. A threaded handle or nut is received over the rod to retain the cover against the housing, and the element fixed within the housing. Some filter assemblies use an eccentric or asymmetric mast (off-center) and an eccentric hole in the end cap-which allows the filter element to be indexed or clocked within the housing and prevents rotation during assembly and use. The eccentric hole could be on the cover or as part of a seal feature on the end cap, or a combination of both.

Prior examples include U.S. Pat. Nos. 10,245,543; 10,350,531; and 10,646,810.

One disadvantage of integrating with eccentric masts is the inability to use standard cylindrical filter parts, i.e., a cylindrical filter where the annular end cap at one end of the element is concentric with the annular end cap at the opposite end. One technique to address this issue is with non-circular filter components, such as an ovate filter element, as shown and described in U.S. Pat. No. 10,350,531, or with entirely eccentric filters as in U.S. Pat. No. 10,646,810. The use of non-circular filters such as these result in shallower pleat depth to accommodate a consistent pleat depth across the geometry, more uneven pleat spacing due to concentrations formed in the corners of non-cylindrical objects, and ultimately a lower threshold of maximum filtration media. Thus, using a cylindrical filter in the same applications would allow the same amount of media with wider pleat spacing to improve particulate filtration with less pressure differential, or a larger amount of media if more filtration area is needed.

Additionally, another disadvantage in the prior designs is that filter elements are only useful with a particular mast design. This increases the cost of manufacturing and prevents standardizing on a single element configuration.

A further disadvantage of horizontally loaded, open ended filter cartridges with or without eccentric masts are the number of seals required. At a minimum, one seal is necessary with the tube sheet/venturi on the housing, and another seal with the cover, in order to maintain integrity of the clean air plenum.

### SUMMARY

In view of the above, new and improved filter cartridges are provided. In particular, new and improved filter cartridges that are reconfigurable or that have eccentric opening for receipt of a threaded rod to secure the filter cartridge to the mast.

With a configurable cylindrical filter cartridge such as described herein, the filter cartridge can fit any number of eccentric mast designs merely by modifying one end cap, and in particular, only a portion of the end cap. Therefore, a single filter product could be used, as one size would fit most solutions within horizontal dust collectors with masts, thus dramatically reducing the inventory cost. A large cost savings can result from optimizing production by limiting product offerings and reducing the variety of inventory required.

Also, in a configurable filter cartridge, a closed end design eliminates the need to seal with the large door of the housing. Instead, sealing is focused on sealing a smaller hole that is intended for the threaded rod. By focusing on a smaller opening, the risk for leaks is reduced. However, given enough threaded rod, the filter could seal itself using the rod by creating a sealed connection with a nut being tightened on the rod, thereby compressing the eccentric washer and eliminating the need for any further integration with the collector.

There are no known cylindrical solutions that integrate with an asymmetric or eccentric mast without greatly oversizing the end cap hole and increasing the risk of leaks.

In one example, a filter element for mounting to a mast of a filter system is provided. The mast has a threaded rod at a distal end thereof. The filter element includes cylindrical filter media, first and second end caps, and a seal washer. The cylindrical media circumscribes a central axis and has first and second ends. The first end cap is a first annular end cap located at the first end of the cylindrical media. The first end cap has a central opening configured for receiving the mast therethrough. The second end cap is located at the second end of the cylindrical media. The second end cap includes a seal washer opening defining a seal washer opening center. The seal washer opening center is located either concentric or non-concentric to the central axis of the cylindrical media. The central opening of the first end cap may be concentric with the central axis. In some examples, the central opening of the first end cap is larger in dimension than the seal washer opening. The seal washer is sealingly receivable within the seal washer opening in at least a first angular orientation relative to the seal washer opening center. In the first angular orientation, a rod hole of the seal washer is non-concentric to the central axis. The rod hole is configured for receiving the threaded rod of the mast.

In one example, the seal washer opening center is non-concentric to the central axis of the cylindrical media. The rod hole is non-concentric within the seal washer opening such that a rod hole center is non-concentric to the seal washer opening center.

In one example, the first end cap includes a mast opening sized to receive the mast there through, the mast opening being concentric to the central axis and non-concentric to the seal washer opening center.

In one example, the seal washer is receivable within the seal washer opening in at least a second angular orientation relative to the seal washer opening center in which the rod hole is concentric to the central axis.

In one example, the seal washer is permanently mounted to the second end cap in the second angular orientation. In another example, the seal washer is removably attached to the second end cap when in the first or second orientations.

In one example, the seal washer has a hub region axially receivable within the seal washer opening in the second end cap in the first angular orientation and in a second angular orientation relative to the seal washer opening center. The rod hole is spaced a first distance from the central axis in the first angular orientation. The rod hole is (a) positioned concentric with the central axis in the second angular orientation or (b) spaced a second distance different than the first distance from the central axis in the second angular orientation.

In one example, the hub region has a circular outer periphery and the seal washer opening has a circular periphery sized to mate sealingly with the circular outer periphery of the hub region.

In one example, the seal washer has an abutment rim that extends radially outward beyond a periphery of the hub region. The abutment rim is sized larger than the seal washer opening. The abutment rim axially abuts the second end cap when installed within the seal washer opening.

In one example, the hub region provides a radially directed seal with the second end cap.

In one example, the hub region is shaped to sealingly mate with the seal washer opening.

In one example, the abutment rim provides an axial seal with the second end cap.

In one example, the hub region has an outer periphery defining a seal washer hub center. The rod hole being non-concentric with the seal washer hub center.

In one example, the outer periphery of the seal washer hub region is circular and the seal washer opening is circular.

In one example, the seal washer includes a resilient seal portion configured to seal with the second end cap and configured for sealing against a threaded rod passing through the rod hole.

In one example, the seal washer includes a rigid backing portion attached to the resilient seal portion. The rigid backing portion having a dimension greater than the dimension of the seal washer opening.

In one example, the seal washer opening is non-concentric to the central axis of the cylindrical media.

In one example, a second seal washer receivable within the seal washer opening is provided. The second seal washer has a second rod hole. The second rod hole being centered within the seal washer opening and concentric with the central axis when the second seal washer is mounted to the second end cap. The seal washer opening is concentric with the central axis.

In an example, a filter element for mounting to a mast of a filter system is provided. The mast having a mounting rod at a distal end thereof. The filter element includes a cylindrical media, first and second end caps, and a seal washer. The cylindrical media circumscribes a central axis and has first and second ends. The first end cap is located at the first end of the cylindrical media. The first end cap has a central opening configured for receiving the mast therethrough. The second end cap is located at the second end of the cylindrical media. The second end cap includes a seal washer opening. The seal washer opening is located either concentric or non-concentric to the central axis of the cylindrical media. The seal washer is sealingly receivable within the seal washer opening and has a rod hole concentric or non-concentric to the central axis. The rod hole is configured for receiving the threaded rod of the mast.

In an example a method of configuring a filter element for use with a mast having a mounting rod is provided. The method includes attaching first end cap to a first end of a tube of filter media. The tube of filter media defines a central axis. The first end cap includes a mast opening configured to allow the mast to extend therethrough. The method includes attaching a second end cap to a second end of the tube of filter media. The second end cap includes a seal washer opening. The seal washer opening is located either concentric or non-centric to the central axis of the tube of filter media. The method includes selecting one of a first seal washer or a second seal washer. The first and second seal washers are configured to be matingly received in the seal washer opening. The first seal washer has a first rod hole spaced a first distance from a first center of the first seal washer. The second seal washer has a second rod hole located a second distance from a second center of the second seal washer. The second distance is different than the first distance. The method includes installing the selected one of the first seal washer or the second seal washer in the seal washer opening.

In one example, the seal washer opening is concentric with the central axis.

In one example, the mast opening of the first end cap is concentric with the central axis.

In an example, a method of configuring a filter element for mounting to a mast having a mounting rod is provided. The method includes attaching a first end cap to a first end of a tube of filter media. The tube of filter media defines a central axis. The first end cap includes a mast opening configured to allow the mast to extend therethrough. The method includes attaching a second end cap to a second end of the tube of filter media. The second end cap includes a seal washer opening defining a seal washer opening center. The seal washer opening center is located non-concentric to the central axis of the tube of filter media. The method includes mounting a seal washer sealingly to the seal washer opening in at least a first angular orientation relative to the seal washer opening center in which a rod hole of the seal washer is non-concentric to the central axis. The rod hole is configured to receive the mounting rod of the mast.

In one example, the seal washer may be mounted in at least a second angular orientation relative to the seal washer opening center in which the rod hole is either (a) non-concentric to the central axis and spaced a different distance from the central axis than when in the first angular orientation or (b) concentric with the central axis.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified partial perspective illustration of a filter system;

FIG. 2 is an enlarged illustration of an end of a filter element mounted to a mast of the filter system of FIG. 1;

FIG. 3 is an end view of an end cap and a seal washer of the filter element of FIG. 1;

FIG. 4 is a cross-sectional illustration of a seal washer according to an example of the application;

FIGS. 5 and 6 are top and bottom views of the seal washer of FIG. 4;

FIGS. 7-9 are top illustrations of the end cap and seal washer of FIG. 3 with the seal washer in different angular orientations illustrating the different locations of the rod hole for use with different mast configurations;

FIG. 10 is a simplified illustration of an alternative end cap in combination with multiple different seal washers allowing for mounting of a filter element to different mast configurations;

FIG. 11 illustrates a filter system having filter elements mounted to eccentric masts; and

FIG. 12 illustrates a filter system having filter elements mounted to standard masts with the threaded post centrally located.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DESCRIPTION

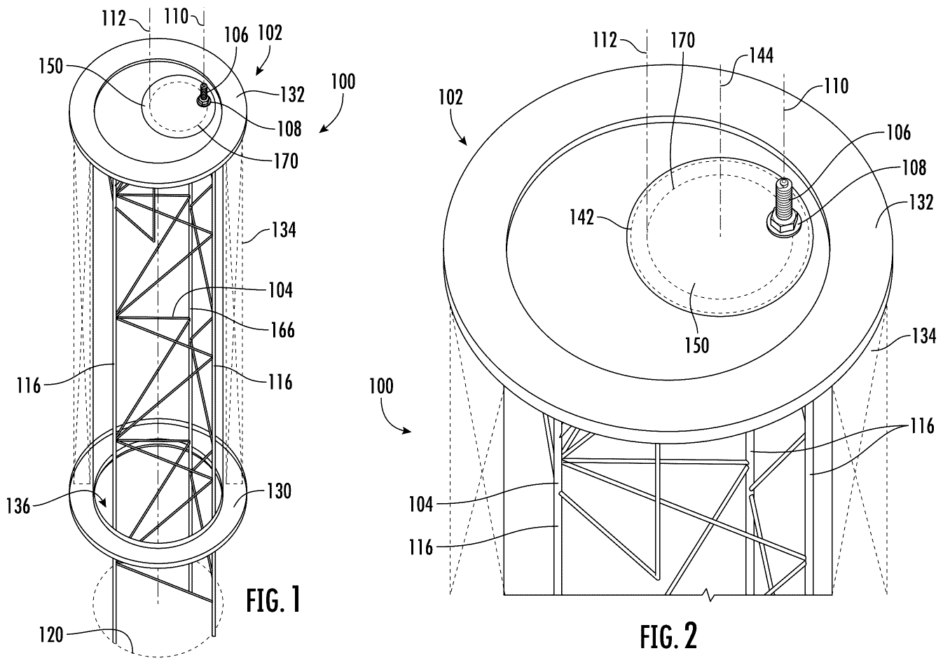

FIG. 1 illustrates a partial example of a filter system 100 according to the present application. The filter system 100 includes a filter element 102 mounted to a mast 104 (also referred to as a yoke 104) of the filter system 100. The filter system 100 is used to filter impurities from a fluid flowing through the filter element 102, such as particulates from air. However, the system 100 can be implemented to filter other fluids.

In the illustrated example, the mast 104 includes a mounting feature in the form of a threaded rod 106 that receives a nut 108 for securing the filter element 102 to the mast 104. Other mounting features are contemplated. In some examples, the nut may also help seal the adjacent end of the filter element 102 to eliminate the need for the filter element 102 to be sealed by other components of the filter system (e.g. housing components).

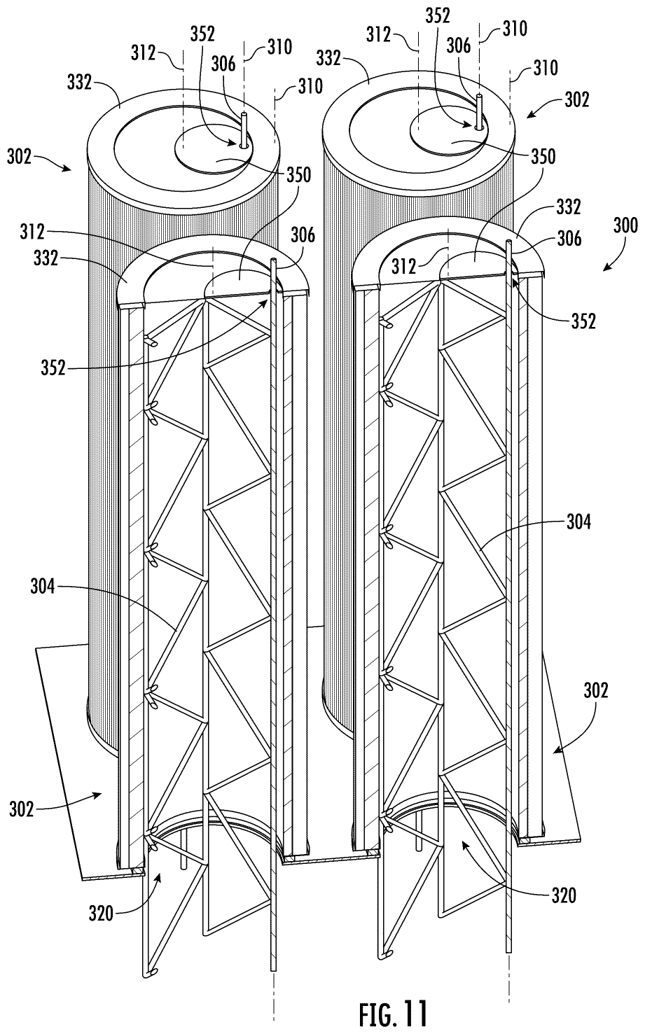

While not illustrated, the mast 104 is typically attached to a portion of a housing such as a tube sheet that includes an aperture therethrough. FIG. 11 has an example of a tube sheet and corresponding flow aperture. An additional arrangement is illustrated in International Patent Application PCT US22/22577 entitled “Filter System, Filter Mounting Mechanism, and Filter Elements Used in and With the Filter System and Filter mounting Mechanism”, the teachings and disclosures of which are incorporated herein in their entirety.

The mast 104 is attached proximate an aperture through the tube sheet and secures the filter element 102 against the tube sheet in a sealing orientation.

In FIG. 1, the threaded rod 106 extends along a first axis 110 (also referred to threaded rod axis 110) that is eccentric to a central second axis 112. Second axis 112 is generally centered on a hypothetical circle 120 defined by the outer periphery of the mast 104, e.g. defined by legs 116 of mast 104.

The filter element 104 includes first and second end caps 130, 132 secured to opposed first and second ends of a cylindrical tube of filter media 134.

The tube of filter media 134 defines a central axis that is co-axial with second axis 112, when mounted to mast 104.

The first end cap 130 is an annular end cap having a mast opening 136 sized and configured to receive the mast 104. In some embodiments, the first end cap 130 is located radially on the legs 116 of the mast 104. Typically, mast opening is concentric with the central axis of the tube of filter media.

The first end cap 130 may be a separate preformed component secured to the end of the filter media 134 such as by way of adhesives or embedding the filter media 134 into the first end cap 130. In other embodiments, the first end cap 130 could be molded directly to the filter media 134. While not shown, a seal may be carried by or provided by the first end cap 130 to seal the first end cap 130 to a filter housing, such as to the tube sheet.

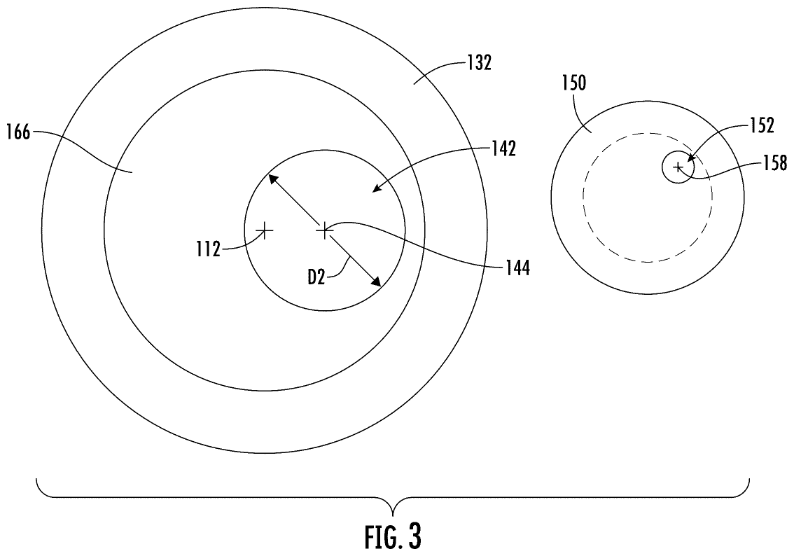

With additional reference to FIG. 3, the second end cap 132 includes a seal washer opening 142 formed therein (see also dashed line 142 in FIG. 2). The seal washer opening 142 has a seal washer opening axis 144 that is offset form the central axis of the tube of filter media 134. For example, the seal washer opening 142 that is offset from the central axis of the tube of filter media 134, again, which is coaxial with second axis 112.

A seal washer 150 is received within the seal washer opening 142. The seal washer 150 includes a rod hole 152 that receives the threaded rod 106 of mast 104 when the filter element 102 is mounted.

The rod hole 152 includes a rod hole axis 158. When mounted in seal washer opening 142, rod hole axis 158 is offset from seal washer axis 144.

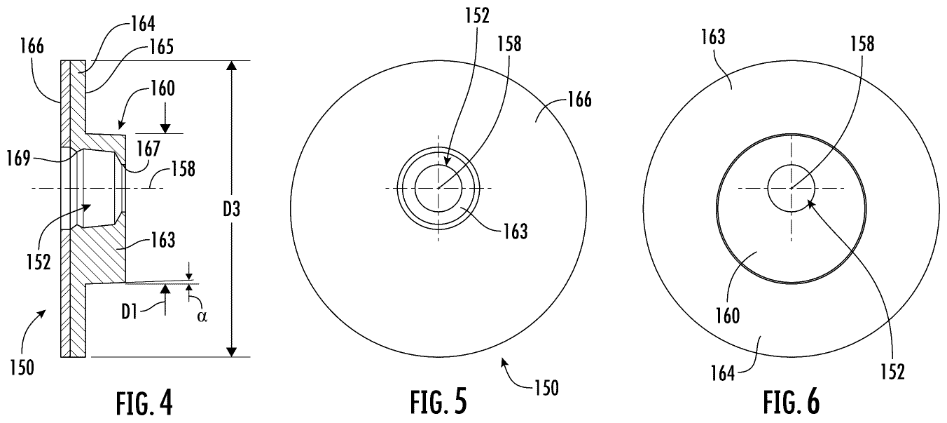

With additional reference to FIGS. 4-6, the seal washer 150 may have a hub region 160 that is axially received within the seal washer opening 142. Preferably, the hub region is shaped and sized to mate with the seal washer opening 142 to provide a seal therebetween. In some examples, the outer dimension D1 of the hub region 160 is slightly larger than the inner dimension D2 of the seal washer opening 142 to provide a tight friction fit therebetween.

In one configuration, the radially outer periphery is circular in cross-section. The outer periphery may taper as illustrated by angle α to make it easier to insert the hub region 160 into the seal washer opening 142.

An abutment rim 164 may extend radially outward beyond the outer periphery of the hub region 160. The abutment rim 164 provides an axial abutment surface 165 that may press axially against a surface of the second end cap 132. Typically, the abutment surface 165 will press against an outer surface 166 of second end cap 132. This can provide an axial seal in addition to the radial seal provided between the radially outer periphery of hub region 160. Further, the pressure of nut 108 can press the seal washer 150 into the second end cap 132.

In other embodiments, the seal washer 150 could be located against an inner surface of the second end cap 132. In such an arrangement, the seal washer 150 could be compressed between the mast 104 and the inner surface of second end cap 150 when the filter element 102 is installed on mast 104.

The abutment rim 164 has an outer dimension D3 that is greater than inner dimension D2 of the seal washer opening 142.

The seal washer 150 may have a resilient body portion 163 that provides one or both of abutment rim 164 and hub region 160 to provide sealing with second end cap 132 preventing fluid leakage therebetween. A reinforcement member in the form of a backing washer 166 may be provided. The backing washer 166 is preferably more rigid than the resilient body portion 163.

The outer dimension of the backing washer 166 need not be greater than dimension D3 but should be greater than dimension D2.

The resilient body portion 163 can be configured to radially seal with the threaded rod 106 so as to fully seal off the filter element 102 rather than requiring the second end cap 132 to be sealed against a housing component. In this instance, the resilient body portion 163 includes a pair of radially inward extending lips 167, 169 that can radially engage the outer periphery of the threaded rod 106 when the filter element 102 is installed. In alternative arrangements, nut 108 or other attachment features could provide sealing between threaded rod 106 and the seal washer 150 to seal this end of the filter element 102.

In one example, the resilient body portion 163 is molded to the backing washer 166. The backing washer 166 could be a metal component such as steel.

In this configuration, both the second end cap 132 and the seal washer 150 have eccentric openings, namely seal washer opening 142 and rod hole 152. By having multiple eccentric features, the filter element 102 can be configurable to align masts that have non-concentric threaded rods 106 using a primarily symmetric, cylindrical filter element 102. Further, this arrangement allows for mounting to masts that have different spacing between the central axis 112 and thread rod axis 110.

This also allows the same filter element 102 to be used with a mast 104 that has a threaded rod axis 110 that is co-axial with central axis 112. Thus, the filter element 102 can be adapted to be used in numerous different filter systems having different mast configurations, thereby reducing the number of different filter elements that must be manufactured.

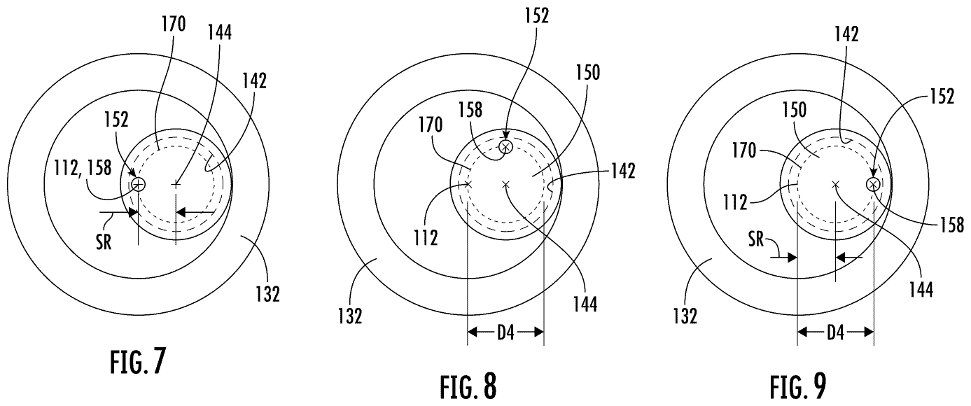

FIGS. 7-9 are simplified illustrates that illustrate the configurability of the filter element 102 due to the inclusion of multiple eccentric components. The second end cap 132 and the seal washer 150 provide a plurality of nested circles (e.g. the circle that defines the tube of filter media 134, the circle that defines the seal washer opening 142, and the circle that defines the rod hole 152.

In FIG. 7, the seal washer 150 is located within seal washer opening 142 such that the rod hole axis 158 is coaxial with central axis 112. More particularly, the seal washer 150 has been angularly orientated relative axis 144 such that rod hole 152 is centered on central axis 112. This allows the filter element 102 to be mounted to a mast 104 that has the threaded rod 106 centered on the rest of the mast 104.

FIG. 8 illustrates the seal washer 150 has been angularly oriented relative to axis 144 such that the rod hole 152 is offset from the central axis 112.

FIG. 9 illustrates the seal washer 150 has been angularly oriented relative to axis 144 such that the rod hole is offset from the central axis 112 a different distance than in FIG. 8. In this angular orientation, the rod hole 152 is at its maximum offset from central axis 112. In this configuration, axes 112, 144, 158 are offset from one another laterally but aligned along a diameter of the filter element 102. In particular, rod hole axis 158 is spaced a distance D4 from central axis 112. This distance is equal to the diameter of the circle 170 defined by the location of axis 158 in the three positioned illustrated in FIGS. 7-9. This circle 170 is the path along which axis 158 travels as the seal washer 150 is rotated 360 degrees about axis 144.

In this example, central axis 112 passes through the seal washer opening 142 which allows the rod hole 152 to be rotated to its position illustrated in FIG. 7 for use with a mast that has the mast axis 110 aligned with the central axis 112.

In this design, the rod hole 152 can be located concentric with central axis 112, at is maximum offset from central axis 112 as illustrated in FIG. 9 or located at any radial position therebetween by simply rotating the seal washer 150 relative to second end cap 132. Thus, this configuration provides for various ranges of eccentricity.

In other words, the rod hole 152 can align with any off-center threaded rod 106 located within an area defined by π(2SR)², where SR is the distance between axis 112 and axis 144 (see FIG. 7).

Other sized seal washers are contemplated that may be smaller than seal washer 150 to reduce expense. However, by providing the double eccentric arrangement, the ability to mate with different mast configurations, albeit fewer mast configurations, is retained.

In some examples, the seal washer 150 could be mountable to the second end cap 132 in the various different angular positions described above and then permanently secured to the second end cap 132. Alternatively, it could be removably attached to the second end cap 132 such that it can be removed without destroying the seal washer 150 or the second end cap.

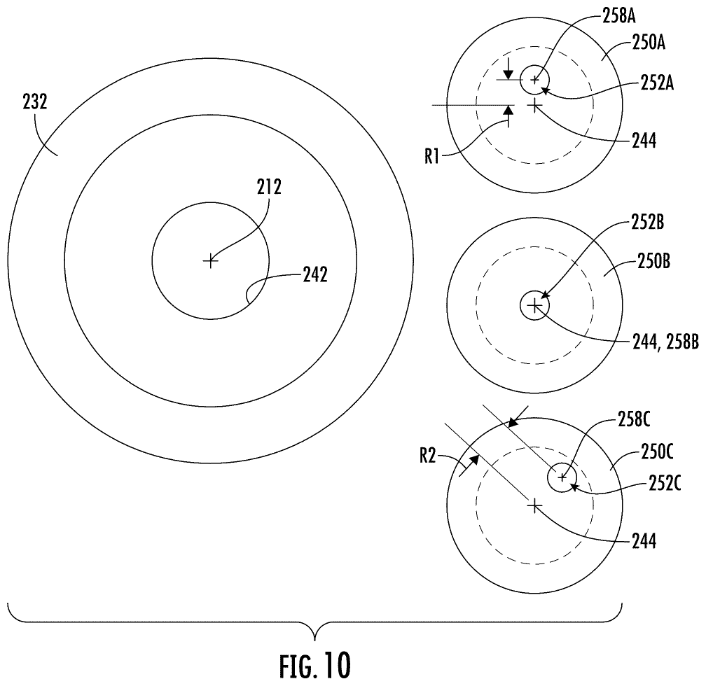

FIG. 10 illustrates a further arrangement. In this arrangement, a second end cap 232 is provided that has a concentric seal washer opening 242. However, a plurality of seal washers 250A, 250B, 250C may be used with second end cap 232 and mounted within seal washer opening 242 that allows for mounting the filter element to different mast configurations. Even if using only a single eccentric feature as in this example, the end cap assembly would still allow easier installation, lessen the difficulties in production and would still allow different mast integrations by selecting the seal washer (e.g. 250A, 250B, 250C, etc.) to mate with the seal washer opening 242 in the second end cap 232.

In this example, seal washer 250A has rod hole 252A offset a first radial distance R1 from axis 244. Seal washer 250C has rod hole 252C offset a second radial distance R2 from axis 244 and seal washer 250B has rod hole 252B centered. Thus, seal washers 250A, 250C would be used with masts having an eccentric threaded rod and seal washer 250B could be used with masts that have a concentric threaded rod.

In this example, each of the seal washers 250A, 250B, 250C could have a common shaped hub region to allow for mating with seal washer opening 242.

The number of masts with which the system could be integrated would be limited to the number of seal washers provided. However, it would minimize new part costs by only requiring a new sealing washer to use the same filter element (e.g. end caps and tube of filter media) in different filter systems.

While the prior designs illustrated using a hub region that had a circular outer periphery, other shapes could be provided. For example, the outer periphery of the hub region could include clocking features that engage mating clocking features provided by the second end cap. This allows for easily locating the seal washer within the seal washer opening for particular mast configurations.

For example, the outer periphery could have radial projections that mate with radial notches in the second end cap.

FIG. 11 is a further simplified illustration of a filter system 300. In this filter system 300, a plurality of filter elements 302 are illustrated. The filter elements 302 are mounted to tube sheet 301 which has openings 320. The system 300 includes masts 304 to which the filter elements 302 are mounted. The masts 304 have offset threaded rods 306 that define offset axis 310 that is laterally offset from the central axis 312. As such, the system 300 is similar to system 100 but has numerous filter elements 302 illustrated.

In this example, seal washer 350 is oriented within the end cap 332 such that rod hole 352 is eccentric to axis 312. In this example, the rod hole 352 is at its maximum distance from axis 312.

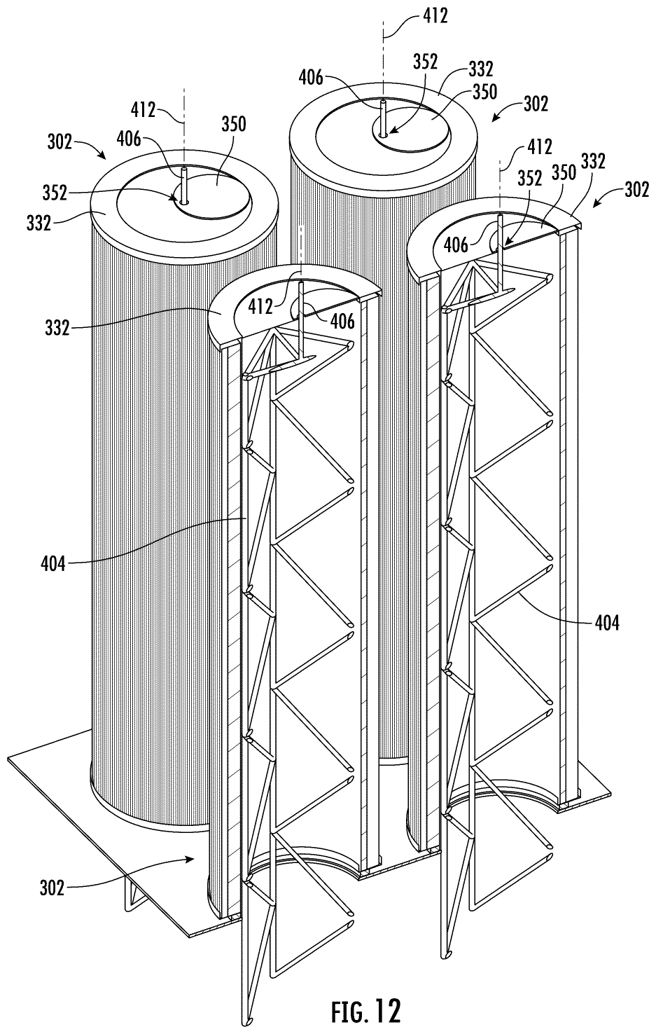

FIG. 12 illustrates another example of a filter system 400. In this example, a modified set of masts 404 are provided. In this example, the threaded rods 406 are centrally located along axis 412. In this example, seal washer 350 has been oriented within the end cap 332 such that the rod hole 352 is eccentric with axis 412.

FIGS. 11 and 12 illustrate how the filter element 302 can be reconfigured to cooperate with different masts while providing a single filter element. In particular, filter element 302 can be used with eccentric style mast 304 as well as a standard mast 404 where the threaded rod 406 is centrally located.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A filter element for mounting to a mast of a filter system, the mast having a mounting rod at a distal end thereof, the filter element comprising:
a. cylindrical media circumscribing a central axis and having first and second ends;
b. a first annular end cap at the first end of the cylindrical media, the first end cap having a central opening;
c. a second end cap at the second end of the cylindrical media, the second end cap including a seal washer opening defining a seal washer opening center, the seal washer opening center located either concentric or non-concentric to the central axis of the cylindrical media; and
d. a seal washer sealingly receivable within the seal washer opening in at least a first angular orientation relative to the seal washer opening center in which a rod hole of the seal washer is non-concentric to the central axis, the rod hole configured for receiving the mounting rod of the mast.

2. The filter element of claim 1, wherein:
the seal washer opening center is non-concentric to the central axis of the cylindrical media; and
the rod hole is non-concentric within the seal washer opening such that a rod hole center is non-concentric to the seal washer opening center.

3. The filter element of claim 2, wherein the central opening of the first end cap is a mast opening sized to receive the mast there through, the mast opening being concentric to the central axis and non-concentric to the seal washer opening center.

4. The filter element of claim 2, wherein the seal washer is receivable within the seal washer opening in at least a second angular orientation relative to the seal washer opening center in which the rod hole is concentric to the central axis.

5. The filter element of claim 4, wherein the seal washer is permanently mounted to the second end cap in the second angular orientation.

6. The filter element of claim 1, wherein:
the seal washer has a hub region axially receivable within the seal washer opening in the second end cap in the first angular orientation and in a second angular orientation relative to the seal washer opening center;
the rod hole being spaced a first distance from the central axis in the first angular orientation; and
the rod hole being positioned concentric with the central axis or spaced a second distance different than the first distance from the central axis in the second angular orientation.

7. The filter element of claim 6, wherein the hub region has a circular outer periphery and the seal washer opening has a circular periphery sized to mate sealingly with the circular outer periphery of the hub region.

8. The filter element of claim 6, wherein:
the seal washer has an abutment rim that extends radially outward beyond a periphery of the hub region;
the abutment rim being sized larger than the seal washer opening; and
the abutment rim axially abutting the second end cap when installed within the seal washer opening.

9. The filter element of claim 7, wherein the hub region provides a radially directed seal with the second end cap.

10. The filter element of claim 8, wherein the abutment rim provides an axial seal with the second end cap.

11. The filter element of claim 6, wherein:
the hub region has an outer periphery defining a seal washer hub center; and
the rod hole being non-concentric with the seal washer hub center.

12. The filter element of claim 11, wherein the outer periphery of the seal washer hub is circular.

13. The filter element as in claim 1, wherein the seal washer includes a resilient seal portion configured to seal with the second end cap and configured for sealing against a mounting rod passing through the rod hole.

14. The filter element as in claim 13, wherein the seal washer includes a rigid backing portion having a dimension greater than the dimension of the seal washer opening.

15. The filter element as in claim 1, wherein the seal washer opening is non-concentric to the central axis of the cylindrical media.

16. The filter element of claim 1, further comprising a second seal washer receivable within the seal washer opening, the second seal washer having a second rod hole, the second rod hole being centered within the seal washer opening and concentric with the central axis when the second seal washer is mounted to the second end cap;
wherein the seal washer opening is concentric with the central axis.

17. A filter element for mounting to a mast of a filter system, the mast having a mounting rod at a distal end thereof, the filter element including:
a. cylindrical media circumscribing a central axis and having first and second ends;
b. a first annular end cap at the first end of the cylindrical media, the first end cap having a central opening configured for receiving the mast therethrough;
c. a second end cap at the second end of the cylindrical media, the second end cap including a seal washer opening, the seal washer opening located either concentric or non-concentric to the central axis of the cylindrical media; and
d. a seal washer sealingly receivable within the seal washer opening and having a rod hole concentric or non-concentric to the central axis, configured for receiving the mounting rod of the mast.

18. A method of configuring a filter element for use with a mast having a mounting rod, the method comprising:
attaching first end cap to a first end of a tube of filter media, the tube of filter media defining a central axis, the first end cap including a mast opening configured to allow the mast to extend therethrough;
attaching a second end cap to a second end of the tube of filter media, the second end cap including a seal washer opening, the seal washer opening located either concentric or non-centric to the central axis of the tube of filter media;
selecting one of a first seal washer or a second seal washer, the first and second seal washers being configured to be matingly received in the seal washer opening, the first seal washer having a first rod hole spaced a first distance from a first center of the first seal washer, the second seal washer having a second rod hole located a second distance from a second center of the second seal washer, the second distance being different than the first distance;
installing the selected one of the first seal washer or the second seal washer in the seal washer opening.

19. The method of claim 18, wherein the seal washer opening is concentric with the central axis.

20. The method of claim 18, wherein the mast opening of the first end cap is concentric with the central axis.

21. A method of configuring a filter element for mounting to a mast having a mounting rod, the method comprising:
attaching a first end cap to a first end of a tube of filter media, the tube of filter media defining a central axis, the first end cap including a mast opening configured to allow the mast to extend therethrough;
attaching a second end cap to a second end of the tube of filter media, the second end cap including a seal washer opening defining a seal washer opening center, the seal washer opening center located non-concentric to the central axis of the tube of filter media; and
mounting a seal washer sealingly to the seal washer opening in at least a first angular orientation relative to the seal washer opening center in which a rod hole of the seal washer is non-concentric to the central axis, the rod hole configured for receiving the mounting rod of the mast.

22. The method of claim 21, wherein the seal washer may be mounted in at least a second angular orientation relative to the seal washer opening center in which the rod hole is either (a) non-concentric to the central axis and spaced a different distance from the central axis than when in the first angular orientation or (b) concentric with the central axis.
